(19) United States
(12) Patent Application Publication
(10) Pub. No.: US 2014/0085226 A1
(43) Pub. Date: Mar. 27, 2014

(54) INTEGRATED SYSTEM OF TOUCH SCREEN AND TOUCH KEY

(71) Applicant: CHUNGHWA PICTURE TUBES, LTD., TAOYUAN (TW)

(72) Inventors: Ching-Lung LI, Kaohsiung City (TW); Jhen-Shen LIAO, Taoyuan County (TW); Hung-Hsiang CHEN, Taoyuan County (TW)

(73) Assignee: CHUNGHWA PICTURE TUBES, LTD., TAOYUAN (TW)

(21) Appl. No.: 13/776,730

(22) Filed: Feb. 26, 2013

(30) Foreign Application Priority Data
Sep. 26, 2012 (TW) 101135357

(51) Int. Cl. G06F 3/041

(52) U.S. Cl. CPC G06F 3/041
USPC 345/173

(57) ABSTRACT

An integrated system of touch screen and touch key includes a touch screen unit, a touch key unit, a microcontroller and a system unit. The touch screen unit generates a first touch sensing signal according to a first touch event. The touch key unit generates a second touch sensing signal according to a second touch event. The microcontroller transforms the first touch sensing signal to a first data packet and transforms the second touch sensing signal to a second data packet. The microcontroller transmits the first data packet to an interface apparatus in the system unit through a first transmission line and transmits the second data packet to the system unit through a second transmission line.

### RELATED APPLICATION

This application claims priority to Taiwan Application Serial Number 101135357, filed Sep. 26, 2012, which is herein incorporated by reference.

### TECHNICAL FIELD

The present disclosure relates to an integrated system, and more particularly to an integrated system of touch screen and touch key.

### BACKGROUND

Almost all present-day smart portable systems use a resistive or capacitive touch screen as a display unit. However, in addition to the touch screen, additional physical keys may be disposed at the bottom of the touch screen to allow a user to realize full operation of the smart portable system. For example, the physical keys may be used to return to the previous screen or return to the home screen. In a typical design, because the physical keys only have an activated voltage state or a deactivated voltage state, that is, a low level voltage state or a high level voltage state, it is possible to realize the function of each physical key by transferring the voltage state thereof in the system through a general purpose input/output (GPIO) pin. However, with respect to the functioning of the touch screen, an integrated circuit is needed to sense and calculate the touch position, and then the touch sensing signals are transmitted in the system. Therefore, the hardware for the touch screen and the hardware for the physical keys are totally different and are designed separately.

However, the physical keys in a smart portable system are utilized at a high rate of frequency. With repeated pressing of the physical keys over a long period of time, the physical keys will become insensitive and even damaged. Therefore, a recent trend is to use touch keys to replace the physical keys. However, an integrated circuit is needed to sense and calculate the touch position. That is, it is impossible to only transmit the touch sensing signals from the touch keys to the general purpose input/output (GM) pins in the system and thereby achieve the key functions as in the case of typical physical keys. In other words, such a structure with the touch screen and touch keys requires the use of two integrated circuits to sense the touch respectively, and this design will increase power consumption and the cost of the system, and the space needed for the components in the system.

### SUMMARY

For resolving the foregoing disadvantages, the present invention provides an integrated touch system using a signal microcontroller to thereby reduce the cost and the space needed for the components in the integrated touch system.

The present invention discloses an integrated system of touch screen and touch key. The integrated system includes a touch screen unit, a touch key unit, a microcontroller and a system unit. The touch screen unit generates a first touch sensing signal according to a first touch event. The touch key unit generates a second touch sensing signal according to a second touch event. The microcontroller is coupled with the touch screen unit and the touch key unit to transform the first touch sensing signal to a first data packet and to transform the second touch sensing signal to a second data packet. The system unit is coupled with the microcontroller. The microcontroller transmits the first data packet to an interface apparatus in the system unit through a first transmission line. The microcontroller also transmits the second data packet to the system unit through a second transmission line.

In an embodiment, the first transmission line is a bus, and the interface apparatus is an Inter-Integrated Circuit (I2C) Interface, a Serial Peripheral Interface (SPO or a Universal Serial Bus (USB) Interface.

In an embodiment, the first data packet comprises a coordinate data generated when the first touch event touches the touch screen unit.

In an embodiment, the second data comprises a first voltage signal and a second voltage signal generated when the second touch event touches the touch key unit.

In an embodiment, the system unit further comprises a General Purpose Input/Output (GPIO) pin to receive the first voltage signal and the second voltage signal.

The present invention discloses an integrated system of touch screen and touch key. The integrated system includes a touch screen unit, a touch key unit, a microcontroller and a system unit. The touch screen unit generates a first touch sensing signal according to a first touch event. The touch key unit generates a second touch sensing signal according to a second touch event. The microcontroller is coupled with the touch screen unit to transform the first touch sensing signal to a first data packet. The system unit is coupled with the microcontroller and the touch key unit. The microcontroller transmits the first data packet to an interface apparatus in the system unit through a first transmission line. The touch key unit transmits the second touch sensing signal to the system unit.

In an embodiment, the first transmission line is a bus, and the interface app, rates is an Inter-Integrated Circuit (I2C) Interface, a Serial Peripheral Interface (SPI) or a Universal Serial Bus (USB) Interface.

In an embodiment, the first data packet comprises a coordinate data generated when the first touch event touches the touch screen unit.

In an embodiment, the system unit further comprises n analog to digital converter (ADC) to receive the second touch sensing signal.

In an embodiment, the analog to digital converter generates a first digital signal or a second digital signal according to the second touch sensing signal.

Accordingly, the touch sensing signals from each of the touch screen unit and the touch key unit are processed by the microcontroller, or alternatively, the touch sensing signals from the touch screen unit are processed by the microcontroller while the touch sensing signals from the touch key unit are directly processed by the system unit. Therefore, only a single microcontroller is needed in the embodiments. Such a structure reduces the cost of the integrated system and the space needed for the components in the integrated system.

### BRIEF DESCRIPTION OF THE DRAWINGS

In order to make the foregoing as well as other aspects, features, advantages, and embodiments of the present disclosure more apparent, the accompanying drawings are described as follows:

FIG. 1 illustrates a schematic diagram of an integrated touch screen and touch key system in accordance with an embodiment of the present invention.

FIG. 2 illustrates a schematic diagram of an integrated touch screen and touch key system in accordance with another embodiment of the present invention.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

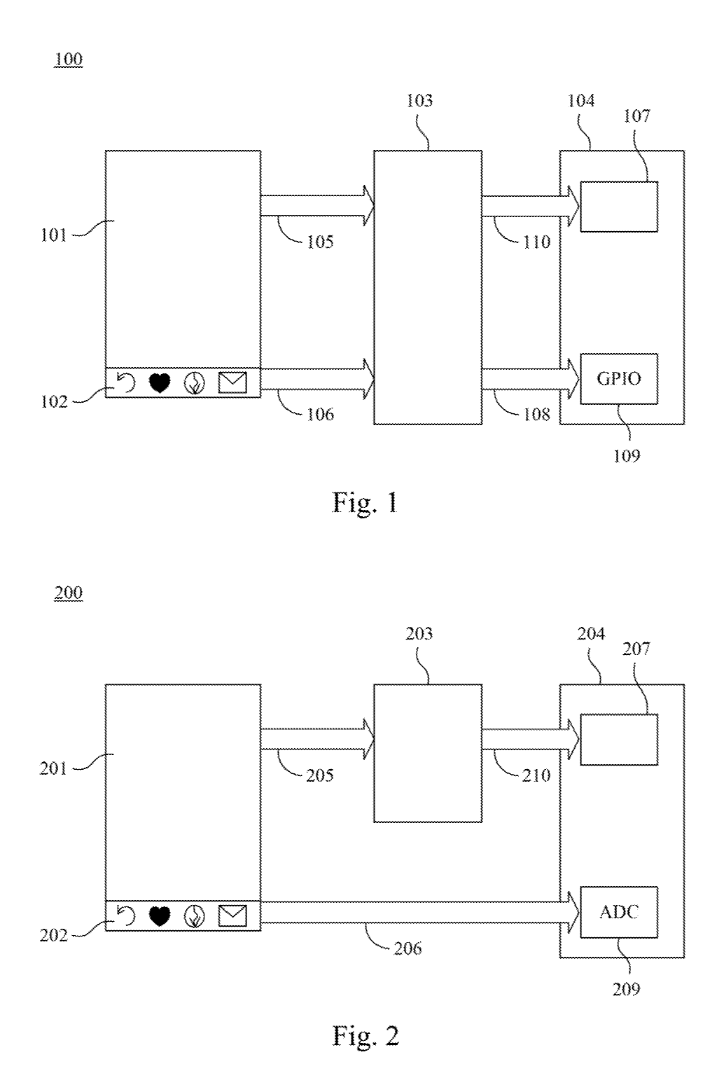

FIG. 1 illustrates a schematic diagram of an integrated system of touch screen and touch key in accordance with an embodiment of the present invention. The integrated system 100 includes a touch screen unit 101, a touch key unit 102, a microcontroller 103 and a system unit 104. The touch key unit 102 is disposed on a side of the touch screen unit 101. The touch screen unit 101 is electrically connected to the microcontroller 103 through a transmission line 105. The touch key unit 102 is electrically connected to the microcontroller 103 through a transmission line 106. The microcontroller 103 is connected to an interface apparatus 107 in the system unit 104 through a transmission line 110. The microcontroller 103 is also connected to a General Purpose Input/Output (GPIO) pin 109 in the system unit 104 through a transmission line 108. In an embodiment, the transmission line 110 is a bus. The system unit 104 further comprises a control unit (not shown). The control unit, for example, is a Central Processing Unit (CPU).

When an object touches the touch screen unit 101, a corresponding touch sensing signal is generated by the touch screen unit 101. This touch sensing signal is transmitted to the microcontroller 103 through the transmission line 105. The touch sensing signal is transformed into coordinate data by the microcontroller 103. The coordinate data is packaged to form a coordinate data packet with a special format. The coordinate data packet is transmitted to the interface apparatus 107 in the system unit 104 through the transmission line 110. In an embodiment, the transmission line 110 is a bus. The interface apparatus 107 is an Inter-Integrated Circuit (I2C) Interface, a Serial Peripheral Interface (SPI) or a Universal Serial Bus (USB) Interface. The system unit 104 uses a first driver program to decode the coordinate data packet. According to the decoded coordinate data, a corresponding operation process is performed by the system unit 104. Subsequently, the performed result is shown on the touch screen unit 101.

Moreover, when an object touches the touch key unit 102, a corresponding touch sensing signal is generated by the touch key unit 102. This touch sensing signal is transmitted to the microcontroller 103 through the transmission line 106. The touch sensing signal is transformed into an on/off data, that is, a high-level voltage data or a low-level voltage data, by the microcontroller 103. The on/off data is packaged to form an on/off data packet with a special format. The on/off data packet is transmitted to the GPIO pin 109 in the system unit 104 through the transmission line 108. The system unit 104 uses a second driver program to decode the on/off data packet. According to the decoded on/off data, a corresponding operation process is performed by the system unit 104. Subsequently, the performed result is shown on the touch screen unit 101.

In this embodiment, only a single microcontroller 103 is needed to package the coordinate data and on/off data. Therefore, the cost of the integrated system is reduced. Moreover, the space needed for the components in the system is reduced. While different driver programs are used to decode the coordinate data packet and the on/off data packet, typical drivers may be used in the embodiment, and it is not necessary to write new driver programs.

FIG. 2 illustrates a schematic diagram of an integrated system of touch screen and touch key in accordance with another embodiment of the present invention. The integrated system 200 includes a touch screen unit 201, a touch key unit 202, a microcontroller 203 and a system unit 204. The touch key unit 202 is disposed on a side of the touch screen unit 201. The touch screen unit 201 is electrically connected to the microcontroller 203 through a transmission line 205. The microcontroller 203 is connected to an interface apparatus 207 in the system unit 204 through a transmission line 210. In an embodiment, the transmission line 210 is a bus. The touch key unit 202 is electrically connected to an analog to digital converter (ADC) 209 in the system unit 204 through a transmission line 206. The system unit 204 further comprises a control unit (not shown). The control unit, for example, is a CPU.

When an object touches the touch screen unit 201, a corresponding touch sensing signal is generated by the touch screen unit 201. This touch sensing signal is transmitted to the microcontroller 203 through the transmission line 205. The touch sensing signal is transformed into coordinate data by the microcontroller 203. The coordinate data is packaged to form a coordinate data packet with a special format. The coordinate data packet is transmitted to the interface apparatus 207 in the system unit 204 through the transmission line 210. In an embodiment, the transmission line 210 is a bus. The interface apparatus 207 is an Inter-integrated Circuit KC) Interface, a Serial Peripheral Interface (SPI) or a Universal Serial Bus (USB) Interface. The system unit 204 uses a first driver program to decode the coordinate data packet. According to the decoded coordinate data, a corresponding operation process is performed by the system unit 204. Subsequently, the performed result is shown on the touch screen unit 201.

Moreover, when an object touches the touch key unit 202, a corresponding touch sensing signal is generated by the touch key unit 202. This touch sensing signal is transmitted to the ADC 209 in the system unit 204 through the transmission line 206. The touch sensing signal is transformed into an on/off data, that is, a digital data of “0” or “1,” by the ADC 209. According to the on/off data, a corresponding operation process is performed by the system unit 204. Subsequently, the performed result is shown on the touch key unit 202. In this embodiment, only a single microcontroller 203 is needed. Therefore, the cost of the integrated system is reduced. Moreover, the space needed for the components in the system is reduced.

Accordingly, with the use of the integrated system of the preferred embodiment, the touch sensing signals from each of the touch screen unit and the touch key unit are processed by the microcontroller, or alternatively, the touch sensing signals from the touch screen unit are processed by the microcontroller while the touch sensing signals from the touch key unit are directly processed by the system unit. Therefore, only a single microcontroller is needed in the embodiments. Such structure reduces the cost of the integrated system and the space needed for the components in the integrated system.

Although the disclosure has been disclosed by the above embodiments, they are not intended to limit the disclosure. It will be apparent to those skilled in the art that various modifications and variations can be made to the structure of the present disclosure may be made without departing from the scope or spirit of the disclosure. Accordingly, the protection scope of the disclosure falls in the appended claims.

What is claimed is:

1. An integrated system of touch screen and touch key, comprising:
a touch screen unit for generating a first touch sensing signal according to a first touch event;
a touch key unit for generating a second touch sensing signal according to a second touch event;
a microcontroller coupled with the touch screen unit and the touch key unit to transform the first touch sensing signal to a first data packet and to transform the second touch sensing signal to a second data packet; and
a system unit coupled with the microcontroller, wherein the microcontroller transmits the first data packet to an interface apparatus in the system unit through a first transmission line, and transmits the second data packet to the system unit through a second transmission line.

2. The integrated system of claim 1, wherein the first transmission line is a bus, and the interface apparatus is an Inter-Integrated Circuit (I2C) Interface, a Serial Peripheral Interface (SPI) or a Universal Serial Bus (USB) Interface.

3. The integrated system of claim 1, wherein the first data packet comprises a coordinate data generated when the first touch event touches the touch screen unit.

4. The integrated system of claim 1, wherein the second data packet comprises a first voltage signal and a second voltage signal generated when the second touch event touches the touch key unit.

5. The integrated system of claim 4, wherein the system unit further comprises a General Purpose Input/Output (GPIO) pin to receive the first voltage signal and the second voltage signal.

6. An integrated system of touch screen and touch key, comprising:
a touch screen unit for generating a first touch sensing signal according to a first touch event;
a touch key unit for generating a second touch sensing signal according to a second touch event;
microcontroller coupled with the touch screen unit to transform the first touch sensing signal to a first data packet; and
a system unit coupled with the microcontroller and the touch key unit, wherein the microcontroller transmits the first data packet to an interface apparatus in the system unit through a first transmission line, and the touch key unit transmits the second touch sensing signal to the system unit.

7. The integrated system of claim 6, wherein the first transmission line is a bus, and the interface apparatus is an Inter-Integrated Circuit (I2C) Interface, a Serial Peripheral Interface (SPI) or a Universal Serial Bus (USB) Interface.

8. The integrated system of claim 6, wherein the first data packet comprises a coordinate data generated when the first touch event touches the touch screen unit.

9. The integrated system of claim 6, wherein the system unit further comprises an analog to digital converter (ADC) to receive the second touch sensing signal.

10. The integrated system of claim 9, wherein the analog to digital converter generates a first digital signal or a second digital signal according to the second touch sensing signal.
